(19) United States
(12) Patent Application Publication
(10) Pub. No.: US 2015/0186095 A1
(43) Pub. Date: Jul. 2, 2015

(54) INTER-TERMINAL IMAGE SHARING METHOD, TERMINAL DEVICE, AND COMMUNICATIONS SYSTEM

(71) Applicant: Huawei Technologies Co., Ltd., Shenzhen (CN)

(72) Inventors: Hao Dong, Shenzhen (CN); Dong Tang, Hangzhou (CN); Liu Yang, Wuhan (CN)

(21) Appl. No.: 14/581,691

(22) Filed: Dec. 23, 2014

Related U.S. Application Data
(63) Continuation of application No. PCT/CN2014/081255, filed on Jun. 30, 2014.

(30) Foreign Application Priority Data
Dec. 31, 2013 (CN) 201310754796.5

(51) Int. Cl. G06F 3/14; G09G 5/12

(52) U.S. Cl. CPC G06F 3/1431; G09G 5/12; G09G 2370/20

(57) ABSTRACT

An inter-terminal graphic sharing method, a terminal device, and a communications system are provided. The method includes: determining, by the transmit end, a sharing area on a graphic displayed on a screen of the transmit end; processing, by the transmit end, a graphic in a non-sharing area, so as to mask the graphic in the non-sharing area, where the non-sharing area is an area except the sharing area on the graphic displayed on the screen of the transmit end; and sending, by the transmit end, a processed graphic displayed on the screen to the receive end by using a local area network, so that the transmit end and the receive end share a graphic in the sharing area. Thus a part of a graphic is shared between two terminals in a local area network, thereby satisfying a security requirement and a personalized requirement of a user.

### CROSS-REFERENCE TO RELATED APPLICATIONS

This application is a continuation of International Application No. PCT/CN2014/081255, filed on Jun. 30, 2014, which claims priority to Chinese Patent Application No. 201310754796.5, filed on Dec. 31, 2013, both of which are hereby incorporated by reference in their entireties.

### TECHNICAL FIELD

The present invention relates to the field of communications technologies, and in particular, to an inter-terminal graphic sharing method, a terminal device, and a communications system.

### BACKGROUND

With popularization of smart mobile terminals and massive increase of functions and applications provided by smart mobile terminals, nowadays users are no longer satisfied with applications of stand-alone terminals. Users have a higher requirement on interaction and information sharing between different terminals and between different users. Therefore, corresponding alliances, such as the Digital Living Network Alliance (Digital Living Network Alliance, DLNA), are established in the industry. This technology allows interconnection and interworking between all electronic devices in a home, including a mobile phone, a television set, a handwrites, a PAD (a tablet), and the like.

In the prior art, a complete graphic displayed on a screen of a smart terminal can be shared between smart terminals in a local area network environment, where the graphic may be a picture, a video, or the like. However, this method cannot satisfy a personalized requirement of a user or ensure information security.

### SUMMARY

Embodiments of the present invention provide an inter-terminal graphic sharing method, a terminal device, and a communications system, which can implement that terminals share a part of a graphic displayed on a screen so as to satisfy a personalized requirement of a user or ensure information security.

The embodiments of the present invention disclose the following technical solutions:

According to a first aspect, an inter-terminal graphic sharing method is provided, where a connection is established between a transmit end and a receive end by using a local area network, and the method includes:

determining, by the transmit end, a sharing area on a graphic displayed on a screen of the transmit end;

processing, by the transmit end, a graphic in a non-sharing area, so as to mask the graphic in the non-sharing area, where the non-sharing area is an area except the sharing area on the graphic displayed on the screen of the transmit end; and

sending, by the transmit end, data of a graphic which is displayed on the screen and then processed to the receive end by using the local area network, so that the transmit end and the receive end share a graphic in the sharing area.

With reference to the foregoing first aspect, in a first possible implementation manner, before the determining, by the transmit end, a sharing area on a graphic displayed on a screen of the transmit end, the method further includes:

receiving, by the transmit end, a screen sharing request sent by the receive end; and the determining, by the transmit end, a sharing area on a graphic displayed on a screen of the transmit end includes: in response to the screen sharing request from the receive end, determining, by the transmit end, the sharing area on the graphic displayed on the screen of the transmit end.

With reference to the foregoing first aspect or the foregoing first possible implementation manner of the first aspect, in a second possible implementation manner, the processing, by the transmit end, a graphic in a non-sharing area includes:

performing, by the transmit end, monochrome colorization processing on the graphic in the non-sharing area, so as to mask the graphic in the non-sharing area.

According to a second aspect, an inter-terminal graphic sharing method is provided, where a connection is established between a transmit end and a receive end by using a local area network, and the method includes:

receiving, by the receive end, data of a graphic and location information of a non-sharing area that are sent by the transmit end by using the local area network, where the non-sharing area is an area except a sharing area on a graphic displayed on a screen of the transmit end;

processing, by the receive end, a graphic in the non-sharing area on the graphic according to the location information of the non-sharing area, so as to mask the graphic in the non-sharing area; and

outputting and displaying, by the receive end, a processed graphic so that the transmit end and the receive end share a graphic in the sharing area.

With reference to the foregoing second aspect, in a first possible implementation manner, before the receiving, by the receive end, data of a graphic and location information of a non-sharing area that are sent by the transmit end by using the local area network, the method further includes:

sending, by the receive end, a screen sharing request to the transmit end.

With reference to the foregoing second aspect or the foregoing first possible implementation manner of the second aspect, in a second possible implementation manner, the processing, by the receive end, a graphic in the non-sharing area on the graphic according to the location information of the non-sharing area includes:

performing, by the receive end, monochrome colorization processing on the graphic in the non-sharing area on the graphic according to the location information of the non-sharing area, so as to mask the graphic in the non-sharing area.

According to a third aspect a terminal device is provided, where the terminal device is connected, as a transmit end, to a receive end by using a local area network, and the terminal device includes:

an area determining unit, configured to determine a sharing area on a graphic displayed on a screen of the terminal device;

an graphic processing unit, configured to process a graphic in a non-sharing area, so as to mask the graphic in the non-sharing area, where the non-sharing area is an area except the sharing area on the graphic displayed on the screen of the terminal device; and

an information sending unit, configured to send data of a graphic which is displayed on the screen and then processed to the receive end by using the local area network, so that the terminal device and the receive end share a graphic in the sharing area.

With reference to the foregoing third aspect, in a first possible implementation manner, the terminal device further includes:

a request receiving unit, configured to receive, before the area determining unit determines the sharing area on the graphic displayed on the screen of the terminal device, a screen sharing request sent by the receive end; where the area determining unit is specifically configured to in response to the screen sharing request from the receive end, determine the sharing area on the graphic displayed on the screen of the terminal device.

With reference to the foregoing third aspect or the foregoing first possible implementation manner of the third aspect, in a second possible implementation manner,

the graphic processing unit is specifically configured to perform monochrome colorization processing on the graphic in the non-sharing area, so as to mask the graphic in the non-sharing area.

According to a fourth aspect, a terminal device is provided, where the terminal device is connected, as a receive end, to a transmit end by using a local area network, and the terminal device includes:

an information receiving unit, configured to receive data of a graphic and location information of a non-sharing area that are sent by the transmit end by using the local area network, where the non-sharing area is an area except a sharing area on a graphic displayed on a screen of the transmit end;

an graphic processing unit, configured to process a graphic in the non-sharing area on the graphic according to the location information of the non-sharing area, so as to mask the graphic in the non-sharing area; and

an graphic outputting unit, configured to output and display a graphic processed by the graphic processing unit so that the transmit end and the terminal device share a graphic in the sharing area.

With reference to the foregoing fourth aspect, in a first possible implementation manner, the terminal device further includes:

a request sending unit, configured to send a screen sharing request to the transmit end.

With reference to the foregoing fourth aspect or the foregoing first possible implementation manner of the fourth aspect, in a second possible implementation manner, the graphic processing unit is specifically configured to perform monochrome colorization processing on the graphic in the non-sharing area on the graphic according to the location information of the non-sharing area, so as to mask the graphic in the non-sharing area.

According to a fifth aspect, a terminal device is provided, where the terminal device is connected, as a receive end, to a transmit end by using a local area network, and the terminal device includes:

a receiver, configured to receive data of a graphic and location information of a non-sharing area that are sent by the transmit end by using the local area network, where the non-sharing area is an area except a sharing area on a graphic displayed on a screen of the transmit end;

an graphic processing engine, configured to process a graphic in the non-sharing area on the graphic according to the location information of the non-sharing area, so as to mask the graphic in the non-sharing area;

a display controller, configured to output a graphic processed by the graphic processing engine; and

a display screen component, configured to display the graphic output by the display controller so that the transmit end and the terminal device share a graphic in the sharing area.

With reference to the foregoing fifth aspect, in a first possible implementation manner, the terminal device further includes:

a sender, configured to send a screen sharing request to the transmit end.

With reference to the foregoing fifth aspect or the foregoing first possible implementation manner of the fifth aspect, in a second possible implementation manner, the graphic processing engine is specifically configured to perform monochrome colorization processing on the graphic in the non-sharing area on the graphic according to the location information of the non-sharing area, so as to mask the graphic in the non-sharing area.

According to a sixth aspect, a communications system is provided, where the communications system includes at least one transmit end and at least one receive end, where the transmit end is connected to the receive end by using a local area network, the transmit end is the terminal device according to the third aspect, or either the first implementation manner of the third aspect or the second implementation manner of the third aspect, or the receive end is the terminal device according to the fourth aspect, or either the first implementation manner of the fourth aspect or the second implementation manner of the fourth aspect, or the receive end is the terminal device according to the fifth aspect, or either the first implementation manner of the fifth aspect or the second implementation manner of the fifth aspect.

According to embodiments of the present invention, a graphic is divided into a sharing area and a non-sharing area, and a graphic in the non-sharing area is processed, so as to mask the graphic in the non-sharing area, thereby implementing sharing of a part of a graphic between two terminals in a local area network and satisfying a security requirement and a personalized requirement of a user. In addition, in a local area network environment, a screen can be quickly shared between terminals in real time, and graphic transmission between the terminals is performed without using an operator network and without a requirement for support of a central server, thereby avoiding problems existing during transmission through an operator network, such as heavy traffic, transmission delay, and no support for real-time dynamic sharing.

### BRIEF DESCRIPTION OF THE DRAWINGS

To describe the technical solutions in the embodiments of the present invention more clearly, the following briefly introduces the accompanying drawings required for describing the embodiments or the prior art. Apparently, a person of ordinary skill in the art may still derive other drawings from these accompanying drawings without creative efforts.

FIG. 1 is a schematic diagram of an application scenario of an inter-terminal graphic sharing method according to an embodiment of the present invention;

FIG. 2a is a flowchart of an inter-terminal graphic sharing method according to an embodiment of the present invention;

FIG. 2b is a schematic diagram of graphic sharing between terminals according to an embodiment of the present invention;

FIG. 2c is a flowchart of an inter-terminal graphic sharing method according to an embodiment of the present invention;

FIG. 3a is a flowchart of another inter-terminal graphic sharing method according to an embodiment of the present invention;

FIG. 3b is a flowchart of another inter-terminal graphic sharing method according to an embodiment of the present invention;

FIG. 4a is a schematic structural diagram of a terminal device according to an embodiment of the present invention;

FIG. 4b is a schematic structural diagram of another terminal device according to an embodiment of the present invention;

FIG. 5 is a schematic structural diagram of a terminal device according to an embodiment of the present invention;

FIG. 6a is a schematic structural diagram of a terminal device according to an embodiment of the present invention;

FIG. 6b is a schematic structural diagram of another terminal device according to an embodiment of the present invention;

FIG. 7 is a schematic structural diagram of still another terminal device according to an embodiment of the present invention; and

FIG. 8 is a schematic structural diagram of a terminal device according to an embodiment of the present invention.

### DETAILED DESCRIPTION

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

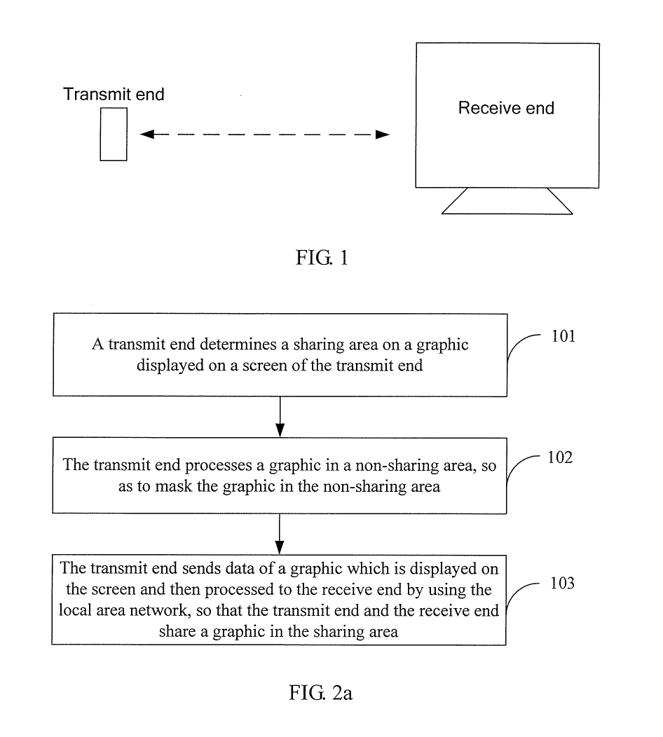

As shown in FIG. 1, FIG. 1 is a schematic diagram of an application scenario in which graphic sharing is performed between terminals in a communications system according to an embodiment of the present invention, where the communications system includes a transmit end and a receive end. A connection is established between the transmit end and the receive end by using a local area network, for example, a connection is established by using Wi-Fi (wireless fidelity). After the connection is established, a screen sharing application is separately started at the transmit end and the receive end, so as to enter a screen sharing mode. In this mode, all operations performed on a screen of the transmit end are considered as operations of selecting a sharing area, and then sharing of information such as a graphic may be performed between the transmit end and the receive end. The transmit end and the receive end may separately be any one of terminals such as a mobile phone, a handwriter, and a PAD separately. The transmit end and the receive end may be terminals of a same type or may be terminals of different types. For example, the transmit end is a mobile phone, and the receive end is a television set. The foregoing graphic may be a single picture, or multiple consecutive graphics in a video, or the like. The foregoing process of establishing a connection between two terminals is not necessarily performed repeatedly each time sharing of information such as a graphic is performed.

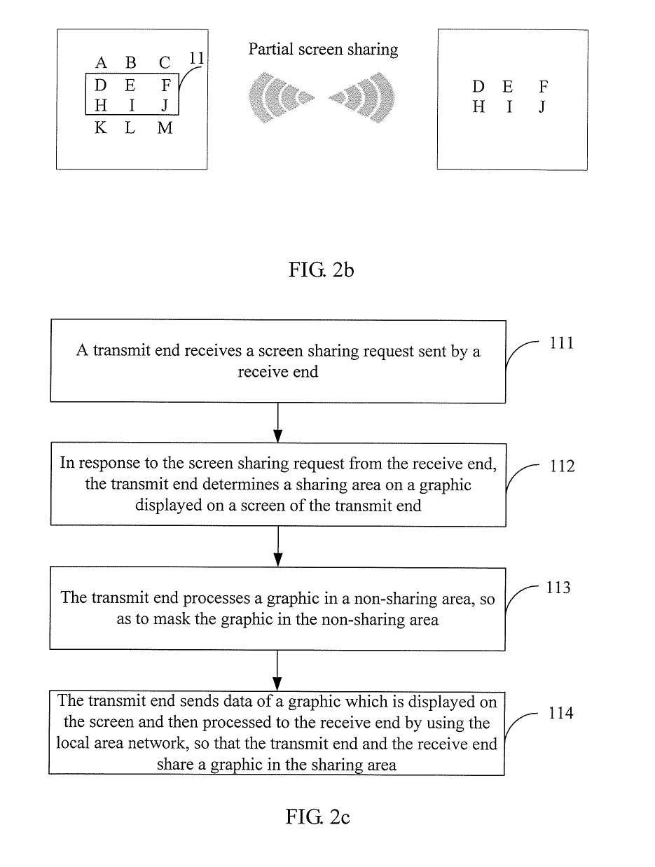

As shown in FIG. 2a, a method for sharing a graphic between a transmit end and a receive end may include the following steps:

Step 101: A transmit end determines a sharing area on a graphic displayed on a screen of the transmit end.

It should be noted that before the transmit end determines the sharing area on the graphic displayed on the screen of the transmit end, a connection needs to be established between the transmit end and the receive end by using a local area network.

When the receive end shares a part of the graphic on the screen with the transmit end, the transmit end first determines a sharing area, in which graphic sharing needs to be performed, on the graphic displayed on the screen of the transmit end, such as a sharing area 11 on the graphic shown in FIG. 2b. An graphic in the sharing area is a graphic that needs to be shared.

The sharing area may specifically be a sharing area selected by a user on the screen of the transmit end. The sharing area may be preset by the user at the transmit end, for example, the sharing area is preset to be an area of a fixed size at the center of the screen; or the sharing area may also be an area temporarily defined by the user when sharing a part of the graphic is performed. The sharing area may be of any shape, and is not necessarily a rectangle.

When determining the sharing area, the transmit end may read coordinates of the sharing area that are preset by the user, or acquire the sharing area defined by the user on the screen to obtain the coordinates of the sharing area. When the sharing area defined by the user on the screen is acquired, a trace generated by a flick of the user on the screen may be obtained first, and it is identified whether the trace is a closed-loop trace or a quasi-closed-loop trace, and if the trace is a closed-loop trace or a quasi-loop trace, an area surrounded by the closed-loop trace or the quasi-closed-loop trace is used as the sharing area.

Step 102: The transmit end processes a graphic in a non-sharing area, so as to mask the graphic in the non-sharing area.

After the transmit end determines the sharing area, the area except the sharing area on the graphic is the non-sharing area. Subsequently, the transmit end needs to process the graphic in the non-sharing area, so as to mask the graphic in the non-sharing area. It should be understood that, compared with an original graphic displayed on the screen, a processed graphic displayed on the screen has masked the graphic in the non-sharing area.

Specifically, monochrome colorization processing may be performed on the graphic in the non-sharing area. For example, all pixels in the graphic in the non-sharing area are whitened or blackened. For example, as shown in FIG. 2b, the graphic in the non-sharing area except the sharing area 11 is all whitened, so as to mask “A, B, C, K, L, and M” in the non-sharing area on the graphic.

The graphic processing process is performed only in memory and is not displayed on the screen of the transmit end. Certainly, other processing may be performed on the graphic in the non-sharing area, so long as the graphic in the non-sharing area can be masked.

Step 103: The transmit end sends data of a graphic which is displayed on the screen and then processed to the receive end by using the local area network, so that the transmit end and the receive end share a graphic in the sharing area.

The transmit end sends the processed graphic to the receive end by using the local area network, where the graphic is a complete graphic that has been processed and is displayed on the screen of the transmit end, and includes both the graphic in the sharing area and the processed graphic in the non-sharing area.

The receive end performs outputting and displaying according to the received graphic. As shown in FIG. 2b, because the graphic in the non-sharing area is whitened and is consistent with a background color of the entire graphic, only the graphic in the sharing area, that is, “D E F H I J”, can be seen by a user on the graphic displayed at the receive end.

When sending the processed graphic, the transmit end may perform coding compression on the data of the processed graphic, and may also perform resolution processing before sending the processed graphic.

According to the embodiment of the present invention, a graphic is divided into a sharing area and a non-sharing area, and a graphic in the non-sharing area is processed, so as to mask the graphic in the non-sharing area, thereby implementing sharing of a part of a graphic between two terminals in a local area network and satisfying a security requirement and a personalized requirement of a user. In addition, in a local area network environment, a screen can be quickly shared between terminals in real time, and graphic transmission between the terminals is performed without using an operator network and without a requirement for support of a central server, thereby avoiding problems existing during transmission through an operator network, such as heavy traffic, transmission delay, and no support for real-time dynamic sharing.

In another embodiment of the present invention, the method for sharing a graphic between a transmit end and a receive end may also be shown in FIG. 2c. A difference of the embodiment from the foregoing embodiment lies in that step 111 is added, in which the transmit end receives a screen sharing request sent by the receive end; and after receiving the request, the transmit end performs step 112, in which in response to the screen sharing request from the receive end, the transmit end determines the sharing area on the graphic displayed on the screen of the transmit end.

Step 112 is similar to the foregoing step 101, step 113 is similar to the foregoing step 102, and step 114 is similar to the foregoing step 103, and details are not described herein again.

In another embodiment of the present invention, one or more graphics may be shared between a transmit end and a receive end. If the transmit end needs to perform partial graphic sharing of multiple pictures (for example, multiple graphics in a video), the foregoing steps may be performed on each graphic to implement partial graphic sharing of each graphic. Sharing areas of all graphics may be the same or may be different.

If the sharing areas of multiple pictures are the same, the transmit end may perform batch processing on the multiple pictures when performing the foregoing steps 102 to 103. For example, when performing step 102, after determining the sharing area, the transmit end may process a graphic in the non-sharing area on each graphic in sequence. When performing step 103, the transmit end sends all processed graphics to the receive end at a time. The foregoing steps may have another variation, which is not limited herein.

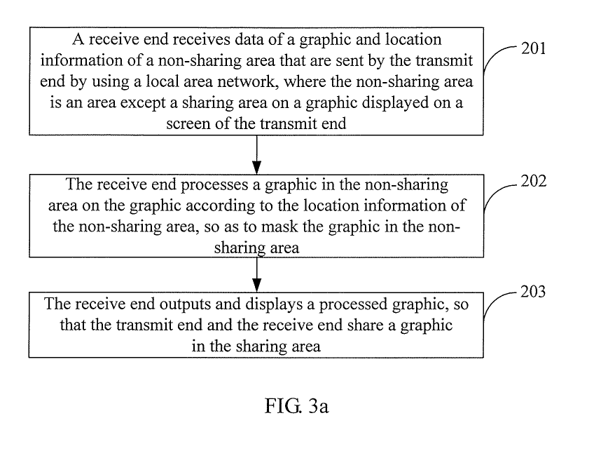

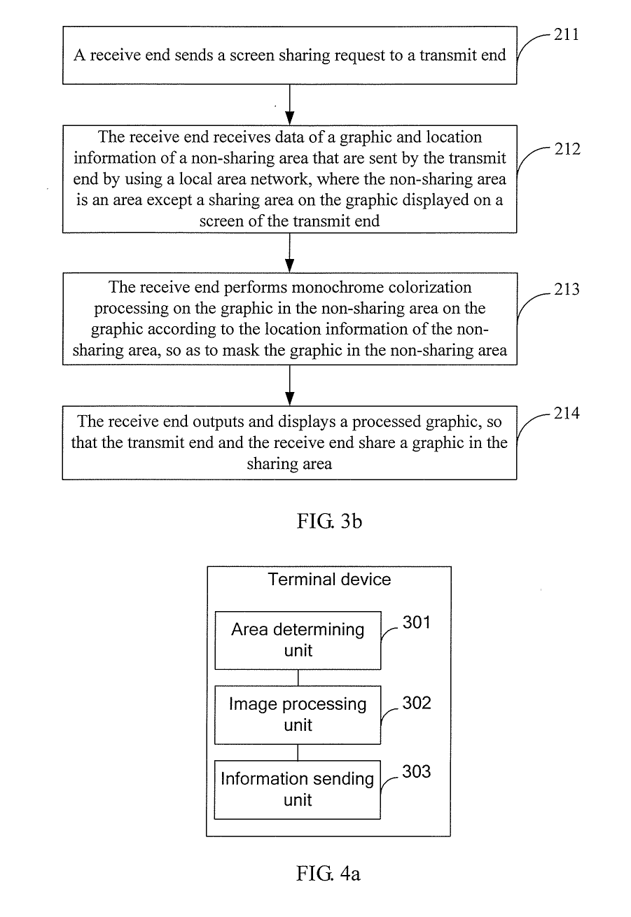

Referring to FIG. 3a, FIG. 3a is a flowchart of another inter-terminal graphic sharing method according to an embodiment of the present invention.

First, a connection is established between a transmit end and a receive end by using a local area network. The method may include the following steps:

Step 201: The receive end receives data of a graphic and location information of a non-sharing area that are sent by the transmit end by using a local area network, where the non-sharing area is an area except a sharing area on a graphic displayed on a screen of the transmit end.

The transmit end first determines the sharing area. The method for determining the sharing area is similar to the foregoing step 101. After the sharing area is determined, the transmit end directly sends a complete graphic displayed on a current screen and the location information of the non-sharing area to the receive end. The location information of the non-sharing area may be a location of coordinates of the non-sharing area on the graphic.

After receiving the foregoing information, the receive end performs step 202.

Step 202: The receive end processes a graphic in the non-sharing area on the graphic according to the location information of the non-sharing area, so as to mask the graphic in the non-sharing area.

The receive end first determines the sharing area and the non-sharing area in the received graphic according to the location information of the non-sharing area. Then, the receive end performs graphic processing on the graphic in the non-sharing area, so as to mask the graphic in the non-sharing area.

Specifically, monochrome colorization processing may be performed on the graphic in the non-sharing area. For example, all pixels in the graphic in the non-sharing area are whitened or blackened. This process is similar to the graphic processing process in the foregoing step 102, and details are not described herein again.

The graphic received by the receive end in the foregoing steps is not displayed on the screen, and the foregoing graphic processing process is performed only in memory. Certainly, other processing may be performed on the graphic in the non-sharing area, so long as the graphic in the non-sharing area can be masked.

Step 203: The receive end outputs and displays a processed graphic, so that the transmit end and the receive end share a graphic in the sharing area.

After processing the graphic, the receive end outputs the processed graphic. In the output graphic, because the graphic in the non-sharing area is masked, for a user, the graphic in the non-sharing area on the original graphic cannot be seen, but the graphic in the sharing area can be seen.

According to the embodiment, a graphic is divided into a sharing area and a non-sharing area, and a graphic in the non-sharing area is processed, so as to mask the graphic in the non-sharing area, thereby implementing sharing of a part of a graphic between two terminals in a local area network and satisfying a security requirement and a personalized requirement of a user. In addition, in a local area network environment, a screen can be quickly shared between terminals in real time, and graphic transmission between the terminals is performed without using an operator network and without a requirement for support of a central server, thereby avoiding problems existing during transmission through an operator network, such as heavy traffic, transmission delay, and no support for real-time dynamic sharing.

In another embodiment of the present invention, the method for sharing a graphic between a transmit end and a receive end may also be shown in FIG. 3b. A difference of the embodiment from the foregoing embodiment lies in that step 211 is added, in which the receive end sends a screen sharing request to the transmit end; and after receiving the request, the transmit end sends information relevant to sharing, and then the receive end performs step 212.

Step 212 is similar to the foregoing step 201, step 213 is similar to the foregoing step 202, and step 214 is similar to the foregoing step 203, and details are not described herein again.

In another embodiment of the present invention, one or more graphics may be shared between a transmit end and a receive end. If the transmit end needs to perform partial graphic sharing of multiple pictures (for example, multiple graphics in a video), the receive end may perform the foregoing steps on each graphic to implement partial graphic sharing of each graphic. Sharing areas of all graphics may be the same or may be different.

If the sharing areas of multiple pictures are the same, the receive end may perform batch processing on the multiple pictures when performing the foregoing step 202. The foregoing steps may have another variation, which is not limited herein.

The foregoing is description of method embodiments of the present invention, and the following describes an apparatus for implementing the forgoing methods.

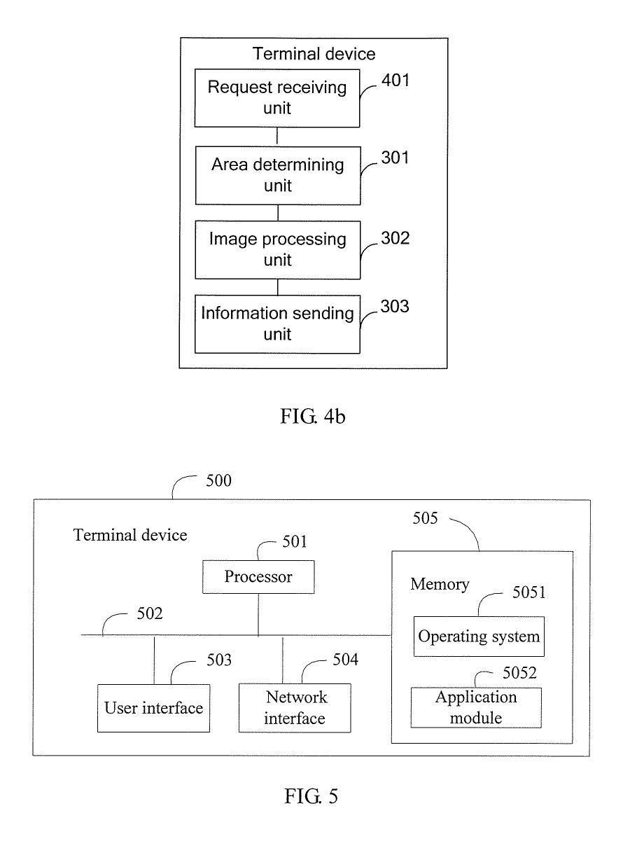

Referring to FIG. 4a, FIG. 4a is a schematic structural diagram of a terminal device according to an embodiment of the present invention.

The terminal device is connected, as a transmit end, to a receive end by using a local area network, and the terminal device may include:

an area determining unit 301, configured to determine a sharing area on a graphic displayed on a screen of the terminal device;

an graphic processing unit 302, configured to process a graphic in a non-sharing area, so as to mask the graphic in the non-sharing area, where the non-sharing area is an area except the sharing area on the graphic displayed on the screen of the terminal device; and

an information sending unit 303, configured to send data of a graphic which is displayed on the screen and then processed to the receive end by using the local area network, so that the terminal device and the receive end share a graphic in the sharing area.

The area determining unit 301 determines the sharing area on the graphic displayed on the screen of the terminal device, where the sharing area may be preset by a user on the terminal device. For example, the sharing area is preset to be an area at the center of the screen; or the sharing area may also be an area temporarily defined by the user when partial screen sharing is performed. The graphic processing unit 302 processes the graphic in the non-sharing area, so as to mask the graphic in the non-sharing area, and then sends a processed graphic to the information sending unit 303, and the information sending unit 303 sends the processed graphic to the receive end.

According to the embodiment of the present invention, a graphic is divided into a sharing area and a non-sharing area by using the foregoing units, and a graphic in the non-sharing area is processed, so as to mask the graphic in the non-sharing area, thereby implementing sharing of a part of a graphic between two terminals in a local area network and satisfying a security requirement and a personalized requirement of a user. In addition, in a local area network environment, a screen can be quickly shared between terminals in real time, and graphic transmission between the terminals is performed without using an operator network and without a requirement for support of a central server, thereby avoiding problems existing during transmission through an operator network, such as heavy traffic, transmission delay, and no support for real-time dynamic sharing.

In another embodiment of the present invention, as shown in FIG. 4b, the terminal device may further include:

a request receiving unit 401, configured to receive, before the area determining unit 301 determines the sharing area on the graphic displayed on the screen of the terminal device, a screen sharing request sent by the receive end.

In another embodiment, the graphic processing unit 302 is specifically configured to perform monochrome colorization processing on the graphic in the non-sharing area, so as to mask the graphic in the non-sharing area.

As shown in FIG. 5, an embodiment of the present invention further provides a terminal device 500, where the terminal device 500 may include: at least one processor 501, such as a central processing unit (CPU); at least one network interface 504, such as a physical network adapter, or another user interface 503; a memory 505; and at least one communications bus 502.

The communications bus 502 is configured to implement connection and communication between these components.

The network interface 504 is configured to implement connection and communication between the terminal device and a network. For example, the network interface 504 may be configured to connect devices such as a physical network adapter and/or a physical switch.

The user interface 503 includes a display, and optionally, may further include a keyboard or another clicking device, such as a mouse, a trackball (trackball), a touchpad, or a touch display screen.

The memory 505 may include a high-speed random access memory (RAM, Random Access Memory), or may further include a non-volatile memory (non-volatile memory), such as at least one disk memory. Optionally, the memory 505 may further include at least one storage apparatus located far away from the foregoing processor 501.

In some implementation manners, the memory 505 stores the following elements, executable modules, or data structures, or their subsets, or their extended sets:

an operating system 5051, including various system programs and configured to implement various basic services and handle hardware-based tasks; and

an application module 5052, including various applications and configured to implement various application services.

Specifically, the processor 501 is configured to: determine a sharing area on a graphic displayed on a screen of the terminal device 500; process a graphic in a non-sharing area, so as to mask the graphic in the non-sharing area, where the non-sharing area is an area except the sharing area on the graphic displayed on the screen of the terminal device; and send data of a graphic which is displayed on the screen and then processed to the receive end by using the local area network, so that the terminal device and the receive end share a graphic in the sharing area.

It may be learned that, according to the terminal device provided in the embodiment of the present invention, a graphic is divided into a sharing area and a non-sharing area, and a graphic in the non-sharing area is processed, so as to mask the graphic in the non-sharing area, thereby implementing sharing of a part of a graphic between two terminals in a local area network and satisfying a security requirement and a personalized requirement of a user. In addition, in a local area network environment, a screen can be quickly shared between terminals in real time, and graphic transmission between the terminals is performed without using an operator network and without a requirement for support of a central server, thereby avoiding problems existing during transmission through an operator network, such as heavy traffic, transmission delay, and no support for real-time dynamic sharing.

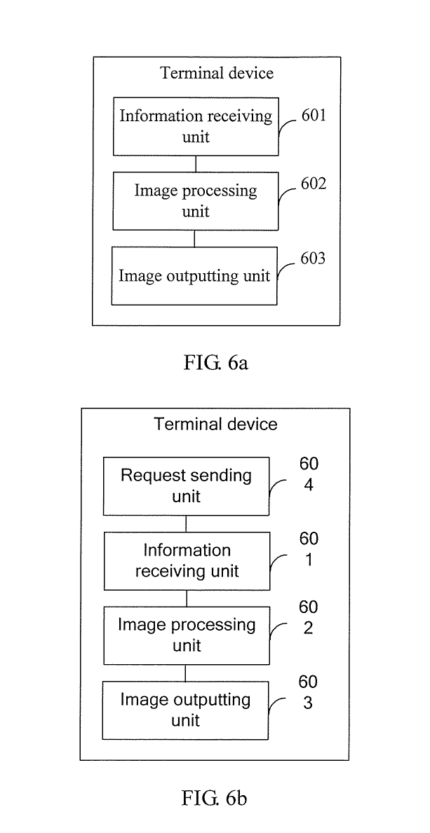

Referring to FIG. 6a, FIG. 6a is a schematic structural diagram of a terminal device according to an embodiment of the present invention.

The terminal device is connected, as a receive end, to a transmit end by using a local area network, and the terminal device may include:

an information receiving unit 601, configured to receive data of a graphic and location information of a non-sharing area that are sent by the transmit end by using the local area network, where the non-sharing area is an area except a sharing area on a graphic displayed on a screen of the transmit end;

an graphic processing unit 602, configured to process a graphic in the non-sharing area on the graphic according to the location information of the non-sharing area, so as to mask the graphic in the non-sharing area; and

an graphic outputting unit 603, configured to output and display a graphic processed by the graphic processing unit, so that the transmit end and the terminal device share a graphic in the sharing area.

According to the embodiment of the present invention, a graphic is divided into a sharing area and a non-sharing area by using the foregoing units, and a graphic in the non-sharing area is processed, so as to mask the graphic in the non-sharing area, thereby implementing sharing of a part of a graphic between two terminals in a local area network and satisfying a security requirement and a personalized requirement of a user. In addition, in a local area network environment, a screen can be quickly shared between terminals in real time, and graphic transmission between the terminals is performed without using an operator network and without a requirement for support of a central server, thereby avoiding problems existing during transmission through an operator network, such as heavy traffic, transmission delay, and no support for real-time dynamic sharing.

In another embodiment of the present invention, as shown in FIG. 6b, the receive end further includes:

a request sending unit 604, configured to send a screen sharing request to the transmit end.

In another embodiment of the present invention, the graphic processing unit 602 is specifically configured to perform monochrome colorization processing on the graphic in the non-sharing area on the graphic according to the location information of the non-sharing area, so as to mask the graphic in the non-sharing area.

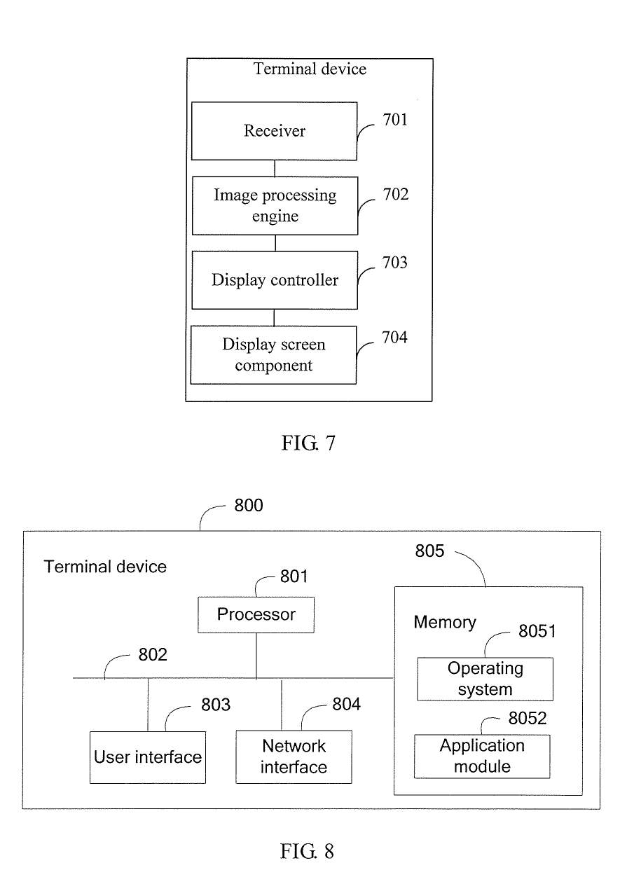

An embodiment of the present invention further provides a terminal device. As shown in FIG. 7, the terminal device is connected, as a receive end, to a transmit end by using a local area network, and the terminal device includes:

a receiver 701, configured to receive data of a graphic and location information of a non-sharing area that are sent by the transmit end by using the local area network, where the non-sharing area is an area except a sharing area on a graphic displayed on a screen of the transmit end;

an graphic processing engine 702, configured to process a graphic in the non-sharing area on the graphic according to the location information of the non-sharing area, so as to mask the graphic in the non-sharing area;

a display controller 703, configured to output a graphic processed by the graphic processing engine 702; and

a display screen component 704, configured to display the graphic output by the display controller, so that the transmit end and the terminal device share a graphic in the sharing area.

In another embodiment of the present invention, the terminal device may further include a sender, configured to send a screen sharing request to the transmit end. In another embodiment of the present invention, the graphic processing engine 702 is specifically configured to perform monochrome colorization processing on the graphic in the non-sharing area on the graphic according to the location information of the non-sharing area.

As shown in FIG. 8, an embodiment of the present invention further provides a terminal device 800, where the terminal device 800 may include: at least one processor 801, such as a CPU; at least one network interface 804, such as a physical network adapter, or another user interface 803; a memory 805; and at least one communications bus 802.

The communications bus 802 is configured to implement connection and communication between these components.

The network interface 804 is configured to implement connection and communication between the terminal device and a network. For example, the network interface 804 may be configured to connect devices such as a physical network adapter and/or a physical switch.

The user interface 803 includes a display, and optionally, may further include a keyboard or another clicking device such as a mouse, a trackball (trackball), a touchpad or a touch display screen.

The memory 805 may include a high-speed random access memory (RAM, Random Access Memory), or may further include a non-volatile memory (non-volatile memory), such as at least one disk memory. Optionally, the memory 805 may further include at least one storage apparatus located far away from the foregoing processor 801.

In some implementation manners, the memory 805 stores the following elements, executable modules, or data structures, or their subsets, or their extended sets:

an operating system 8051, including various system programs and configured to implement various basic services and handle hardware-based tasks; and

an application module 8052, including various applications and configured to implement various application services.

Specifically, the processor 801 is configured to: receive data of a graphic and location information of a non-sharing area that are sent by the transmit end by using the local area network, where the non-sharing area is an area except a sharing area on a graphic displayed on a screen of the transmit end; process a graphic in the non-sharing area on the graphic according to the location information of the non-sharing area, so as to mask the graphic in the non-sharing area; and output and display a processed graphic, so that the transmit end and the terminal device share a graphic in the sharing area.

It may be learned that, in the terminal device provided in the embodiment of the present invention, a graphic is divided into a sharing area and a non-sharing area, and a graphic in the non-sharing area is processed, so as to mask the graphic in the non-sharing area, thereby implementing sharing of a part of a graphic between two terminals in a local area network and satisfying a security requirement and a personalized requirement of a user. In addition, in a local area network environment, a screen can be quickly shared between terminals in real time, and graphic transmission between the terminals is performed without using an operator network and without a requirement for support of a central server, thereby avoiding problems existing during transmission through an operator network, such as heavy traffic, transmission delay, and no support for real-time dynamic sharing.

An embodiment of the present invention further provides a communications system. The communications system may include at least one transmit end and at least one receive end, and the transmit end is connected to the receive end by using a local area network.

The transmit end is configured to: determine a sharing area on a graphic displayed on a screen of the transmit end; and process a graphic in a non-sharing area, so as to mask the graphic in the non-sharing area, where the non-sharing area is an area except the sharing area on the graphic displayed on the screen of the transmit end; and send data of a graphic which is displayed on the screen and then processed to the receive end by using the local area network, so that the transmit end and the receive end share a graphic in the sharing area.

In another embodiment, the transmit end is further configured to receive, before the transmit end determines the sharing area on the graphic displayed on the screen of the transmit end, a screen sharing request sent by the receive end.

The transmit end is specifically configured to perform monochrome colorization processing on the graphic in the non-sharing area, so as to mask the graphic in the non-sharing area.

An embodiment of the present invention further provides a communications system. The communications system may include at least one transmit end and at least one receive end, and the transmit end is connected to the receive end by using a local area network.

The receive end is configured to: receive data of a graphic and location information of a non-sharing area that are sent by the transmit end by using the local area network, where the non-sharing area is an area except a sharing area on a graphic displayed on a screen of the transmit end; process a graphic in the non-sharing area on the graphic according to the location information of the non-sharing area, so as to mask the graphic in the non-sharing area; and output and display the processed graphic so that the transmit end and the receive end share the graphic in the sharing area.

In another embodiment, the receive end is further configured to send a screen sharing request to the transmit end before the receive end receives the data of a graphic and location information of the non-sharing area that are sent by the transmit end by using the local area network.

The receive end is specifically configured to perform monochrome colorization processing on the graphic in the non-sharing area on the graphic according to the location information of the non-sharing area, so as to mask the graphic in the non-sharing area.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of the present invention essentially, or the part contributing to the prior art, or a part of the technical solutions may be implemented in a form of a software product. The software product is stored in a storage medium and includes several instructions for instructing a computer device (which may be a personal computer, a server, or a network device) or a processor to perform all or a part of the steps of the methods described in the embodiments of the present invention. The foregoing storage medium includes: any medium that can store program code, such as a USE flash drive, a removable hard disk, a read-only memory (ROM, Read-Only Memory), a random access memory (RAM, Random Access Memory), a magnetic disk, or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. An inter-terminal graphic sharing method, wherein a connection is established between a transmit end and a receive end by using a local area network, and the method comprises:
determining, by the transmit end, a sharing area on a graphic displayed on a screen of the transmit end;
processing, by the transmit end, a graphic element in a non-sharing area, so as to mask the graphic element in the non-sharing area, wherein the non-sharing area is an area except the sharing area on the graphic displayed on the screen of the transmit end; and
sending, by the transmit end, data of a graphic which is displayed on the screen of the transmit end and then processed to the receive end by using the local area network, so that the transmit end and the receive end share a graphic element in the sharing area.

2. The method according to claim 1, wherein:
before determining, by the transmit end, a sharing area on a graphic displayed on a screen of the transmit end, the method further comprises:
receiving, by the transmit end, a screen sharing request sent by the receive end; and
determining, by the transmit end, a sharing area on a graphic displayed on a screen of the transmit end comprises:
in response to the screen sharing request from the receive end, determining, by the transmit end, the sharing area on the graphic displayed on the screen of the transmit end.

3. The method according to claim 1, wherein processing, by the transmit end, a graphic element in a non-sharing area, so as to mask the graphic element in the non-sharing area comprises:
performing, by the transmit end, monochrome colorization processing on the graphic element in the non-sharing area, so as to mask the graphic element in the non-sharing area.

4. An inter-terminal graphic sharing method, wherein a connection is established between a transmit end and a receive end by using a local area network, and the method comprises:
receiving, by the receive end, data of a graphic and location information of a non-sharing area that are sent by the transmit end by using the local area network, wherein the non-sharing area is an area except a sharing area on the graphic displayed on a screen of the transmit end;
processing, by the receive end, a graphic element in the non-sharing area on the graphic according to the location information of the non-sharing area, so as to mask the graphic element in the non-sharing area; and
outputting and displaying, by the receive end, a graphic element, which is obtained by processing the graphic element in the non-sharing area on the graphic, in a sharing area on the graphic displayed on a screen of the receive end, so that the transmit end and the receive end share the graphic element in the sharing area.

5. The method according to claim 4, wherein before receiving, by the receive end, data of a graphic and location information of a non-sharing area that are sent by the transmit end by using the local area network, the method further comprises:
sending, by the receive end, a screen sharing request to the transmit end.

6. The method according to claim 4, wherein processing, by the receive end, a graphic element in the non-sharing area on the graphic according to the location information of the non-sharing area, so as to mask the graphic element in the non-sharing area comprises:
performing, by the receive end, monochrome colorization processing on the graphic element in the non-sharing area on the graphic according to the location information of the non-sharing area, so as to mask the graphic element in the non-sharing area.

7. A terminal device, wherein the terminal device is connected, as a transmit end, to a receive end by using a local area network, and the terminal device comprises:
a memory; and
a processor coupled with the memory, configured to:
determine a sharing area on a graphic displayed on a screen of the terminal device,
process a graphic element in a non-sharing area, so as to mask the graphic element in the non-sharing area, wherein the non-sharing area is an area except the sharing area on the graphic displayed on the screen of the terminal device, and
send data of a graphic which is displayed on the screen of the terminal device and then processed to the receive end by using the local area network, so that the terminal device and the receive end share a graphic element in the sharing area.

8. The terminal device according to claim 7, wherein the processor is further configured to:
receive a screen sharing request sent by the receive end; and
in response to the screen sharing request from the receive end, determine the sharing area on the graphic displayed on the screen of the terminal device.

9. The terminal device according to claim 7, wherein the processor is further configured to:
perform monochrome colorization processing on the graphic element in the non-sharing area, so as to mask the graphic element in the non-sharing area.

10. A terminal device, wherein the terminal device is connected, as a receive end, to a transmit end by using a local area network, and the terminal device comprises:
a memory; and
a processor coupled with the memory, configured to:
receive data of a graphic and location information of a non-sharing area that are sent by the transmit end by using the local area network, wherein the non-sharing area is an area except a sharing area on a graphic displayed on a screen of the transmit end,
process a graphic element in the non-sharing area on the graphic according to the location information of the non-sharing area, so as to mask the graphic element in the non-sharing area, and
output and display a graphic element, which is obtained by processing the graphic element in the non-sharing area on the graphic, in the sharing area on the graphic displayed on the screen of the receive end, so that the transmit end and the terminal device share the graphic element in the sharing area.

11. The terminal device according to claim 10, wherein the processor is further configured to:
send a screen sharing request to the transmit end.

12. The terminal device according to claim 10, wherein the processor is further configured to:
perform monochrome colorization processing on the graphic element in the non-sharing area on the graphic according to the location information of the non-sharing area, so as to mask the graphic element in the non-sharing area.

13. A terminal device, wherein the terminal device is connected, as a receive end, to a transmit end by using a local area network, and the terminal device comprises:
a receiver, configured to receive data of a graphic and location information of a non-sharing area that are sent by the transmit end by using the local area network, wherein the non-sharing area is an area except a sharing area on a graphic displayed on a screen of the transmit end;
an graphic processing engine, configured to process a graphic element in the non-sharing area on the graphic according to the location information of the non-sharing area, so as to mask the graphic element in the non-sharing area;
a display controller, configured to output a graphic element, which is obtained by processing the graphic element in the non-sharing area on the graphic; and
a display screen component, configured to display the graphic element output by the display controller in the sharing area on the graphic displayed on the screen of the terminal device, so that the transmit end and the terminal device share the graphic element in the sharing area.

14. The terminal device according to claim 13, further comprising:
a sender, configured to send a screen sharing request to the transmit end.

15. The terminal device according to claim 13, wherein the graphic processing engine is configured to perform monochrome colorization processing on the graphic element in the non-sharing area on the graphic according to the location information of the non-sharing area, so as to mask the graphic element in the non-sharing area.

16. A communications system comprising:
at least one transmit end connected to at least one receive end using a local area network;
wherein the receive end is configured to send a screen sharing request;
wherein the transmit end is configured to:
in response to the screen sharing request from the receive end, determine a sharing area on a graphic displayed on a screen of the terminal device,
process a graphic element in a non-sharing area, so as to mask the graphic element in the non-sharing area, wherein the non-sharing area is an area except the sharing area on the graphic displayed on the screen of the transmit end, and
send data of a graphic which is displayed on the screen of the terminal device and then processed to the receive end by using the local area network; and
wherein the receive end is further configured to receive the data of the graphic which is displayed on the screen of the transmit end and then processed by using the local area network, and display a graphic element in the sharing area on a graphic displayed on a screen of the receive end, so that the transmit end and the terminal device share the graphic element in the sharing area.

17. A communications system comprising:
at least one transmit end connect to at least one receive end using a local area network;
wherein the transmit end is configured to:
receive a screen sharing request from the receive end, and
send data of a graphic displayed on a screen of the transmit end and location information of a non-sharing area on a graphic displayed on the screen of the transmit end by using the local area network, wherein the non-sharing area is an area except a sharing area on the graphic displayed on the screen of the transmit end; and
wherein the receive end is configured to:
receive the data of the graphic and the location information of the non-sharing area that are sent by the transmit end by using the local area network, wherein the non-sharing area is an area except a sharing area on the graphic displayed on the screen of the transmit end,
process a graphic element in the non-sharing area on the graphic according to the location information of the non-sharing area, so as to mask the graphic element in the non-sharing area, and
output and display a graphic element in the sharing area on a graphic displayed on a screen of the receive end, so that the transmit end and the terminal device share the graphic element in the sharing area.
